(19) United States
(12) Patent Application Publication
(10) Pub. No.: US 2018/0260801 A1
(43) Pub. Date: Sep. 13, 2018

(54) DATA GATHERING FOR PAYMENT PROCESSING

(71) Applicant: International Business Machines Corporation, Armonk, NY (US)

(72) Inventors: Giacomo G. Chiarella, Eastleigh (GB); Anna Jackson, Southampton (GB); Mitul Ranpuria, Bebington (GB); Andrew J. Seymour, Southampton (GB); Liam A. White, Hook (GB)

(21) Appl. No.: 15/453,954

(22) Filed: Mar. 9, 2017

(51) Int. Cl. G06Q 20/22

(52) U.S. Cl. CPC G06Q 20/227; G06K 9/00221

(57) ABSTRACT

Disclosed embodiments provide techniques for payment processing. A purchase context is obtained by examining data from one or more electronic information systems. Based on information from the electronic information system(s), a probability score is computed. The probability score reflects the likelihood that a particular purchase should be associated with a particular account. Various factors are used in determining the probability score. These include, but are not limited to, the date and time of an event associated with the purchase, the name of a merchant associated with the purchase, contacts with the user at the time of the purchase, and/or a geographical location at which the purchase is made. Based on these factors, a determination of which account the user should use to complete the purchase is determined. The purchase is then completed using the associated account from a mobile electronic device such as a smartphone or tablet computer.

### FIELD OF THE INVENTION

Embodiments of the invention relate generally to data gathering, and more particularly, to data gathering for payment processing.

### BACKGROUND

Many people have several bank accounts. A person may have a personal checking account, a personal savings account, a personal credit card, a business credit card, a joint account with another person, etc. Furthermore, some people are signers on business accounts, such as company officers and executives. Some people are signers on multiple business accounts, such as an operating account and an escrow account. Many times, things are even more complex, as sometimes these accounts are at different financial institutions. A person may desire that certain purchases come out of particular accounts. For example, a person may want her groceries to be purchased from a personal account, a bank CD purchased from a savings account, and office supplies purchased from a business account. It can be difficult to manage payments from multiple accounts. There exists a need to improve data gathering for payment processing.

### SUMMARY

In one aspect, there is provided a computer-implemented method for determining a correct account for a purchase, comprising: obtaining context information from one or more electronic information systems; determining a probability score of the purchase corresponding to an account, based on the obtained context information from the one or more electronic information systems; and associating the purchase with the account in response to the probability score exceeding a predetermined threshold.

In another aspect, there is provided an electronic device comprising: a processor; a memory coupled to the processor, the memory containing instructions, that when executed by the processor, perform the steps of: obtaining context information from one or more electronic information systems; determining a probability score of a purchase corresponding to an account, based on the obtained context information from the one or more electronic information systems; and associating the purchase with the account in response to the probability score exceeding a predetermined threshold.

In yet another aspect, there is provided a computer program product for determining a correct account for a purchase on an electronic computing device, the electronic computing device comprising a computer readable storage medium having program instructions embodied therewith, the program instructions executable by a processor to cause the electronic computing device to: obtain context information from one or more electronic information systems; determine a probability score of the purchase corresponding to an account, based on the obtained context information from the one or more electronic information systems; and associate the purchase with the account in response to the probability score exceeding a predetermined threshold.

### BRIEF DESCRIPTION OF THE DRAWINGS

Features of the disclosed embodiments will be more readily understood from the following detailed description of the various aspects of the invention taken in conjunction with the accompanying drawings.

FIG. 1 is a block diagram of a device in accordance with embodiments of the present invention.

FIG. 2 shows a system in accordance with embodiments of the present invention.

FIG. 3 is a flowchart indicating process steps for embodiments of the present invention.

FIG. 4 is a diagram illustrating computerized attire analysis of a user.

FIG. 5 is an example illustrating contacts that are identified by a computer-implemented facial recognition process performed on an image acquired by a user device.

FIG. 6 is a flowchart indicating process steps for account association in accordance with embodiments of the present invention.

FIG. 7 is a flowchart indicating process steps for account association in accordance with additional embodiments of the present invention.

FIG. 8 is a flowchart indicating process steps for account association in accordance with additional embodiments of the present invention.

FIG. 9 is an exemplary user interface for account confirmation in accordance with embodiments of the present invention.

FIG. 10 is an exemplary user interface for automatic account selection in accordance with embodiments of the present invention.

FIG. 11 illustrates associating the purchase with the account in response to detecting a fingerprint from a fingerprint sensor.

FIG. 12A and FIG. 12B illustrate account association based on device orientation.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Disclosed embodiments provide techniques for payment processing. A purchase context is obtained by examining data from one or more electronic information systems. The electronic information systems can include, but are not limited to, social media systems, electronic calendar systems, geolocation systems, and/or image acquisition systems. Based on information from the electronic information systems(s), a probability score is computed. The probability score reflects the likelihood that a particular purchase should be associated with a particular account (e.g., a business account or a personal account). A variety of factors are used in determining the probability score. These include, but are not limited to, the date and time of an event associated with the purchase, the name of a merchant associated with the purchase, contacts with the user at the time of the purchase, and/or a geographical location at which the purchase is made. Based on these factors, a determination of which account the user should use to complete the purchase is determined. The purchase is then completed using the associated account from a mobile electronic device such as a smartphone or tablet computer. Thus, disclosed embodiments greatly simplify the management of personal and business accounts.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, integers, steps, operations, elements, components, and/or groups thereof.

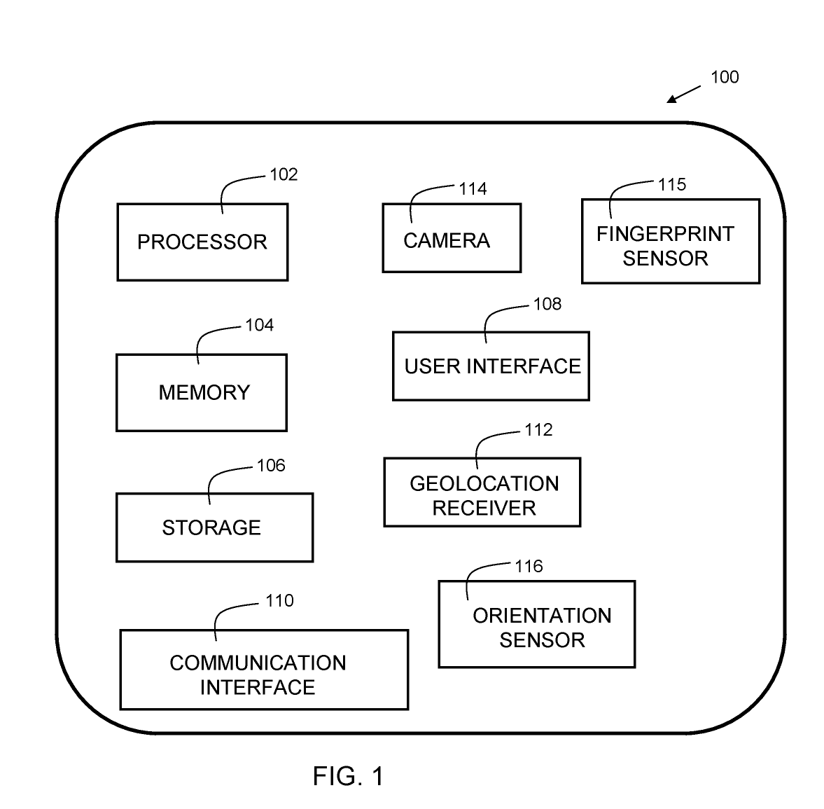

FIG. 1 is a block diagram of a device in accordance with embodiments of the present invention. Device 100 is shown as a simplified diagram of modules. Device 100 is an electronic computing device. Device 100 includes a processor 102, which is coupled to a memory 104. Memory 104 may include dynamic random access memory (DRAM), static random access memory (SRAM), magnetic storage, and/or a read only memory such as flash, EEPROM, optical storage, or other suitable memory. In some embodiments, the memory 104 may not be a transitory signal per se. Memory 104 includes instructions, which when executed by the processor, implement steps of the present invention.

Device 100 may further include storage 106. In embodiments, storage 106 may include one or more magnetic storage devices such as hard disk drives (HDDs). Storage 106 may include one or more solid state drives (SSDs). Any other storage device may be included instead of, or in addition to, those disclosed herein.

Device 100 may further include a user interface 108, examples of which include a liquid crystal display (LCD), a plasma display, a cathode ray tube (CRT) display, a light emitting diode (LED) display, an organic LED (OLED) display, or other suitable display technology. The user interface 108 may further include a keyboard, mouse, and/or a touch screen, incorporating a capacitive or resistive touch screen in some embodiments.

The device 100 may further include a communication interface 110. In some embodiments, the communication interface 110 may include a wireless communication interface that includes modulators, demodulators, and antennas for a variety of wireless protocols including, but not limited to, Bluetooth™, Wi-Fi, and/or cellular communication protocols for communication over a computer network.

The device 100 may further include a geolocation receiver 112. Geolocation receiver 112 may be any type of location-detecting system. For example, it may include a global positioning (satellite) system, triangulation system, or other suitable technology.

The device 100 may further include an orientation sensor 116. Orientation sensor may be an accelerometer and/or tilt sensor. Orientation sensor 116 senses and determines the orientation of the device 100. In embodiments, the orientation can be a vertical (portrait) orientation, in which the device is oriented such that it is longer in the vertical direction than in the horizontal direction. In embodiments, the orientation can be a horizontal (landscape) orientation, in which the device is oriented such that it is longer in the horizontal direction than in the vertical direction.

The device 100 may further include a camera 114. The camera can be a user-facing camera that can acquire digital images of a user. The device may encode geolocation data obtained from geolocation receiver 112 into an image header of an acquired digital image. The geolocation data may include longitude and latitude coordinates.

The device 100 may further include a fingerprint sensor 115. A fingerprint sensor is an electronic device that captures a digital image of a fingerprint pattern. The image, called a live scan, is digitally processed to produce a biometric template (a collection of extracted features) which is stored in memory for utilization in matching.

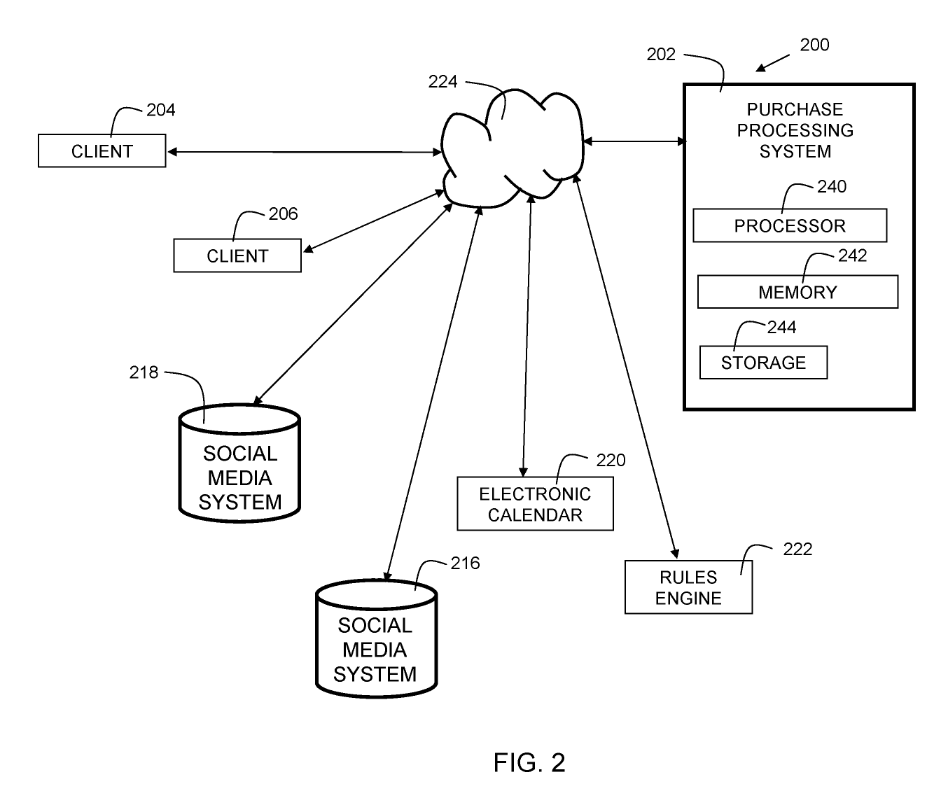

FIG. 2 shows an environment 200 for implementation of embodiments of the invention. A purchase processing system 202 includes a processor 240, memory 242, and storage 244. Purchase processing system 202 includes instructions stored in memory 242 for executing elements of embodiments of the present invention. System 202 is in communication with client devices 204 and 206, and one or more electronic information systems including social media system 216, social media system 218, electronic calendaring system 220, and rules engine 222 through network 224. In embodiments, network 224 may be the Internet, a wide area network (WAN), a local area network (LAN), a corporate intranet, a cloud computing network, or other suitable network. Client devices 204 and 206 may be any suitable electronic devices. Examples include smartphones, tablet computers, laptop computers, desktop computers, etc. In addition, although only two client devices are shown, in embodiments, more or fewer client devices may be included.

Social media system 216 and social media system 218 may each comprise instructions and memory for executing social media platforms. Social media platforms may include Facebook®, Twitter®, LinkedIn®, Instagram®, and/or any other social media platform now known or hereafter developed. For example, system 216 may include Facebook® and system 218 may include LinkedIn®. In addition, although only two social media systems are shown, in embodiments, more or fewer social media systems may be included.

Electronic calendaring system 220 may, in some embodiments, be a calendar shared among a group of people, such as a shared electronic calendar. In some embodiments, the calendar may instead be personal to the user, such as a calendaring application installed on the user's phone.

Rules engine 222 stores in memory a set of rules for assigning weights to factors based on the likelihood that the factor indicates a purchase is of a particular type of expense as opposed to another (e.g., business versus personal). In some embodiments, the rules engine 222 may be accessible to the purchase processing system 202 via network 224. In other embodiments, the rules engine 222 may be local to the purchase processing system 202.

Purchase processing system 202 includes instructions for determining from which account a purchase should be made. System 202 includes account information either entered manually from a user, or imported, for example, from a bank. Alternatively, system 202 may communicate with a payment redirection system (e.g., via an API), for example Apple Pay or Android Pay, to select the proper account based on the acquired purchase context information. When an account is stored or accessed by purchase processing system 202, it is labeled either from account metadata, or manual entry from a user, which type of account it is. For example, account types may include “business,” “personal,” “business1,” “business2,” “personal_checking,” “personal_savings,” “personal_credit_card,” “business_credit_card,” etc. If a person has two business accounts, s/he may designate a first one “business1” and a second one “business2.” If a person has a personal checking and personal savings account, s/he may designate them as “personal_checking” and “personal_savings,” respectively. Alternatively, the system 202 may associate a type from information imported from the bank, such as title of the account, signer on the account, amount in the account, etc.

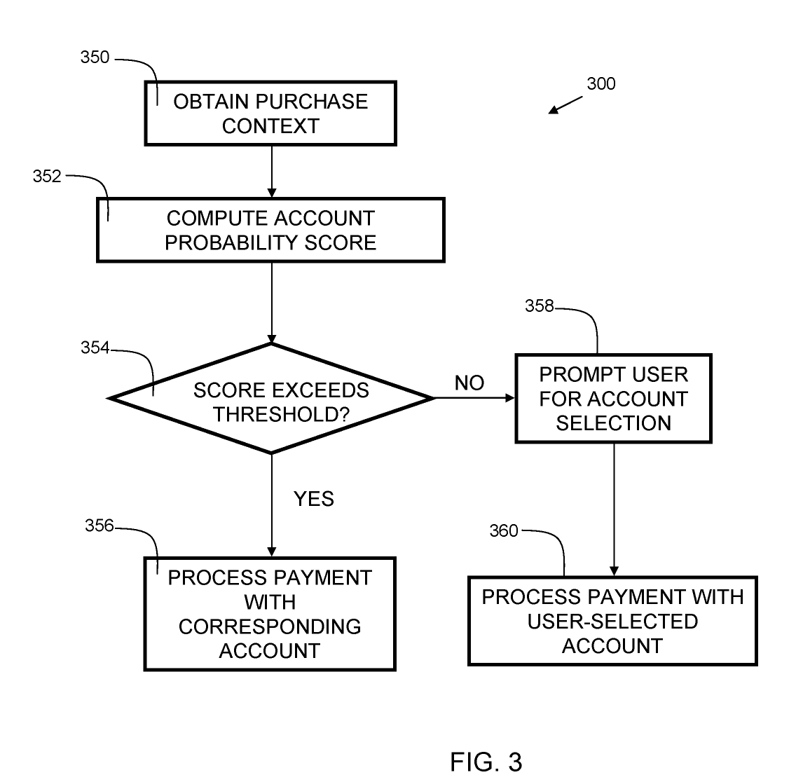

FIG. 3 is a flowchart 300 indicating process steps for embodiments of the present invention. At 350, a purchase context is obtained. At 352, an account probability score is computed. The probability score reflects the likelihood that a particular purchase should be associated with a particular account (e.g., a business account or a personal account). A rules engine, analyzing a variety of elements, assigns weights, based on predetermined rules, to different factors to determine the probability score. The elements include, but are not limited to, social media systems, electronic calendars, maps, etc. Examples of factors used from those elements include, but are not limited to, date and time of an event associated with the purchase, merchant associated with the purchase, contacts with the user at the time of the purchase, and/or a geographical location at which the purchase is made. The type of event (event classification) may also be considered as a factor. For example, an event type can include a movie, a trade show, a seminar, a theater play, etc. Thus, in embodiments, the context information includes an event classification for an event. The factors are weighted to compute the probability score. At 354, it is determined whether the account probability score exceeds a predetermined threshold. Note that in some embodiments, it is determined whether the account probability score is, instead, below the predetermined threshold. If so, payment is processed with the corresponding account, at 356. If not, the user is prompted for account selection, at 358. Payment is then processed with the user-selected account, at 360.

In some embodiments, purchase context information includes an event date for an event. A date that falls on a weekday, such as Monday, Tuesday, Wednesday, Thursday, or Friday may indicate it is more likely a business purchase than a purchase occurring on a weekend day, such as a Saturday or Sunday. For example, if a user purchases a set of theatre tickets for June 2^{nd}, system 202 (FIG. 2) may query an electronic calendaring system 220 (FIG. 2) to determine on what day of the week June 2^{nd} falls. If it falls on a Saturday, it may be assigned a weight indicating a high probability of being a personal expense. If it falls on a Wednesday, rules engine 222 (FIG. 2) may assign a weight indicating a high probability of being a business expense (e.g., a thank you gift to a client).

In some embodiments, purchase context information includes an event time for an event. A time that falls within typical business hours may indicate that the purchase is more likely a business purchase than a personal one. For example, if the purchase is made between 9:00 a.m. and 5:00 p.m., it is more likely a business expense than a purchase made at 7:00 p.m. since many people work from 9:00 a.m. to 5:00 p.m., and are on personal time outside of that window. For example, if a user purchases a set of tickets for a show at 7:00 p.m., rules engine 222 (FIG. 2) will assign a weight indicating a high probability of being a personal expense. If the tickets instead are for a show at 11:00 a.m., rules engine 222 (FIG. 2) will assign a weight indicating a high probability of being a business expense (e.g., a presentation at a conference).

In some embodiments, purchase context information includes one or more contacts associated with the event. In some embodiments, the one or more contacts are identified by a computer-implemented facial recognition process performed on an image acquired by a user device. A user may post a “selfie” to a social media site within a predetermined window prior to the purchase. Alternatively, a user may take and store such a photo in his/her phone within that time period. For example, the window may be 1 hour prior. The selfie may be taken using the user facing camera of FIG. 1. System 202 of FIG. 2 may either scan a social media system, or a photos folder on the user's phone, to determine whether an image was taken within the window time. If it finds such an image, system 202 may analyze the image, and using facial recognition software, locate at least one person in addition to the user in the photo. System 202 may scan social media systems 216 and 218 to determine how the user knows the at least one other person in the photo. If the relationship between the user and the other person in the photo is determined to be a personal relationship, rules engine 222 (FIG. 2) assigns a weight indicating a personal expense. If the relationship between the user and the other person in the photo is determined to be a business relationship, rules engine 222 (FIG. 2) assigns a weight indicating a business expense.

For example, in some embodiments, rules of rules engine 222 (FIG. 2) may indicate that if the user's user account is connected to the other person's user account on a first particular social networking system, a weight is assigned indicating a high probability that the user knows that person through business. If the user accounts are connected by a second social networking system, then a weight will be assigned indicating a high probability that the user knows that person on a personal level.

In some embodiments, purchase context information includes geographic location of the purchase based on “check-in” data. System 202 (FIG. 2) may scan a social networking system to determine whether a user “checked in” at a location within a predetermined time frame of the purchase, such as within the past hour of the attempted purchase. If a check-in is found within the time window, the location is analyzed to determine whether the visit is likely business or personal. For example, if the location is a print shop, rules engine 222 (FIG. 2) will assign a weight that indicates a high probability that the purchase is a business expense. If the location is a children's play place, rules engine 222 (FIG. 2) will assign a weight indicating a high probability that the purchase is a personal expense.

In some embodiments, purchase context information includes a geographic location based on information obtained using a geolocation receiver 112 of the user device. If the purchase is being made from within a predetermined geographic radius of a user's home, it is more likely a personal expense. If the purchase is being made from within a predetermined geographic radius of the user's office, the purchase is more likely a business expense. For example, if the predetermined radius is three miles, when the user makes a purchase at a coffee shop two miles from his/her home, rules engine 222 (FIG. 2) will assign a weight to the factor to indicate it is more likely a personal expense. In another example, if the predetermined radius is three miles, when the user makes a purchase at a coffee shop two miles from his/her work, rules engine 222 (FIG. 2) will assign a weight to the factor to indicate it is more likely a business expense.

In some embodiments, purchase context information includes a destination associated with a purchase. For example, if the purchase is a plane ticket, train ticket, ferry ticket, etc., where data about a destination is included, such data may be captured and analyzed by system 202 (FIG. 2). If a user who works in the automotive industry, books a plane ticket to Miami, Fla., a big vacation destination, it is more likely personal than if the ticket is destined for Detroit, Mich., where a large portion of the auto industry is situated in the United States. If the destination is indicated as Las Vegas, a neutral weight may be assigned to the factor since Las Vegas is a major tourism center as well as business conference area.

In some embodiments, purchase context information includes a merchant identification for the purchase. The classification may be determined based on a merchant category. A merchant category can be any of a number of types of differentiators. For example, a purchase from a wholesaler is much more likely a business purchase than from a retailer. A purchase from an office supply store is more likely a business purchase than a purchase from a shoe retailer. A purchase from a grocery store is more likely a personal purchase than a purchase from a web hosting company. A purchase from a rental car agency may be given a neutral weight since a car rental may be made when a user's personal car, or business car, breaks down. Any suitable categories may be used. Rules engine 222 (FIG. 2) assigns weights accordingly.

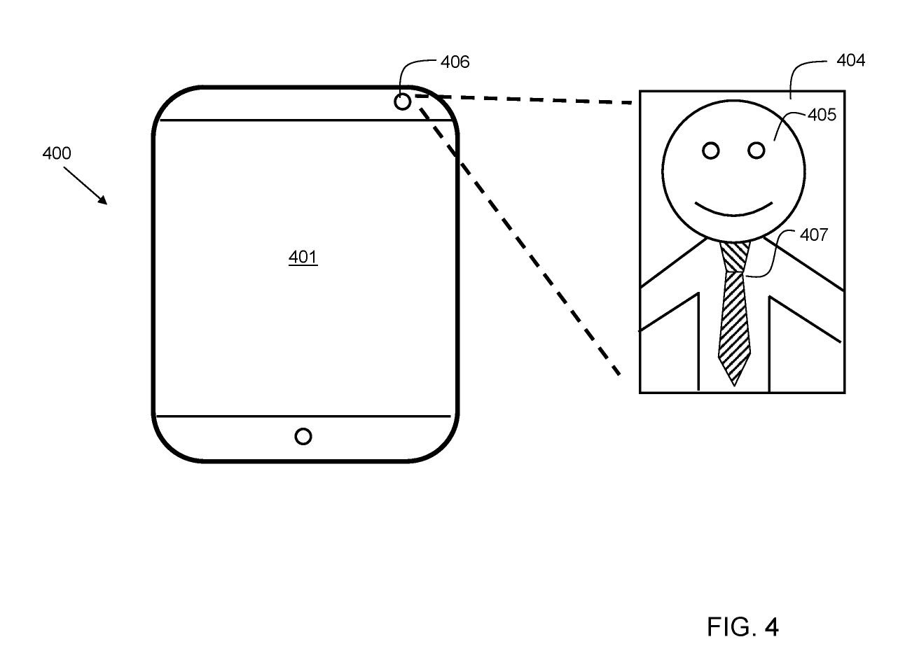

In some embodiments, purchase context is based on user attire. FIG. 4 is a diagram 400 illustrating computerized attire analysis of a user. In some embodiments, a user facing camera (FIG. 1) may capture an image of the user within a particular time window of a purchase, for example, within an hour before the purchase. The image, whether it is a photo, video, or live feed, is analyzed to determine the type of attire the user is wearing. For example, system 202 (FIG. 2) may use image processing/object recognition technology to determine whether the user is in business attire or casual attire. In the example, user device phone 401 has user facing camera 406. The camera takes image 404 of user 405.

In embodiments, image processing techniques can be used to determine that user 405 is wearing a necktie 407. The image processing techniques can include edge detection, gradient processing, pattern recognition, and/or other suitable techniques. In some embodiments, machine learning may be used to recognize the user's attire. In some embodiments, the machine learning can include classification using Support Vector Machine (SVM) classifiers, random forests, and/or transfer forests. In some embodiments, a convolutional neural network (CNN) system may be used for performing the image processing. The machine learning may be supervised machine learning, in which a plurality of training images are used to train the system to recognize business attire. The image processing may include a clothing type classification, where the clothing type classification may include, but is not limited to, classifications of hat, jacket, shirt, and/or necktie. This information can be used as a criterion in determining the context of the purchase and, thus, which account should be used to complete the purchase. In the example of FIG. 4, the image processing determines that the user 405 is wearing a necktie 407. Rules engine 222 (FIG. 2) therefore assigns a weight to the attire factor that indicates a high likelihood a purchase is a business expense since a necktie 407, as compared to, for example, a t-shirt, is likely business attire.

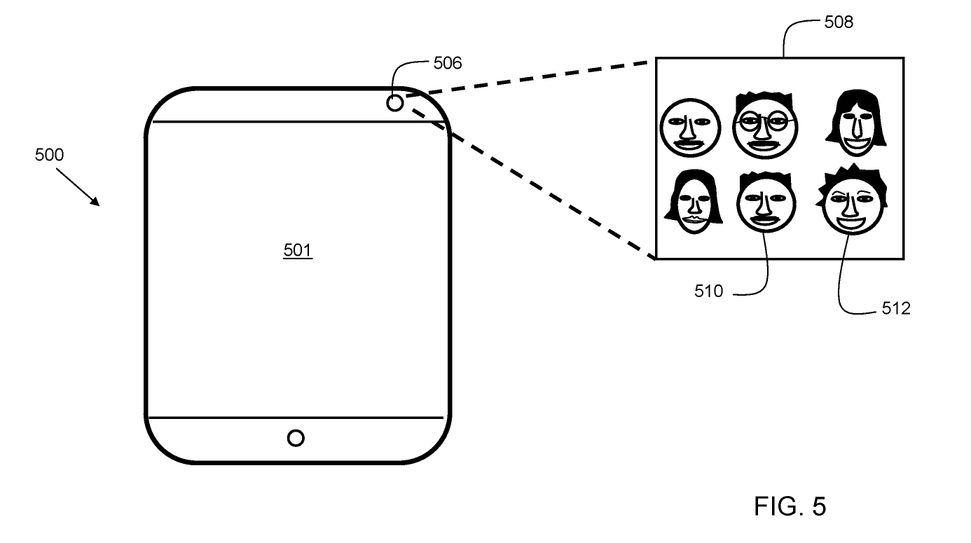

In some embodiments, purchase context is based on user contacts. FIG. 5 is a diagram 500 illustrating contacts that are identified by a computer-implemented facial recognition process performed on an image acquired by a user device. In some embodiments, a user facing camera (FIG. 1) may capture a photo (i.e. a “selfie”), of the user within a particular time window of a purchase (i.e., within an hour before the purchase). The image, whether it is a photo, video, or live feed, is analyzed, using facial recognition technology, to determine other people in the photo with the user. For example, system 202 (FIG. 2) may use image processing techniques to determine who the user is with near or at the time of the purchase. In the example, user device, phone 501, has user facing camera 506. The camera takes image 508. Facial recognition technology is used to determine that the photo includes user 510 and friend 512. Rules engine 222 (FIG. 2) then assigns a weight to the context information that indicates a high likelihood that the purchase is a personal expense since the user being with a friend, as compared to, for example, a co-worker, is likely a personal excursion. Thus, in embodiments, the context information includes one or more contacts associated with the event.

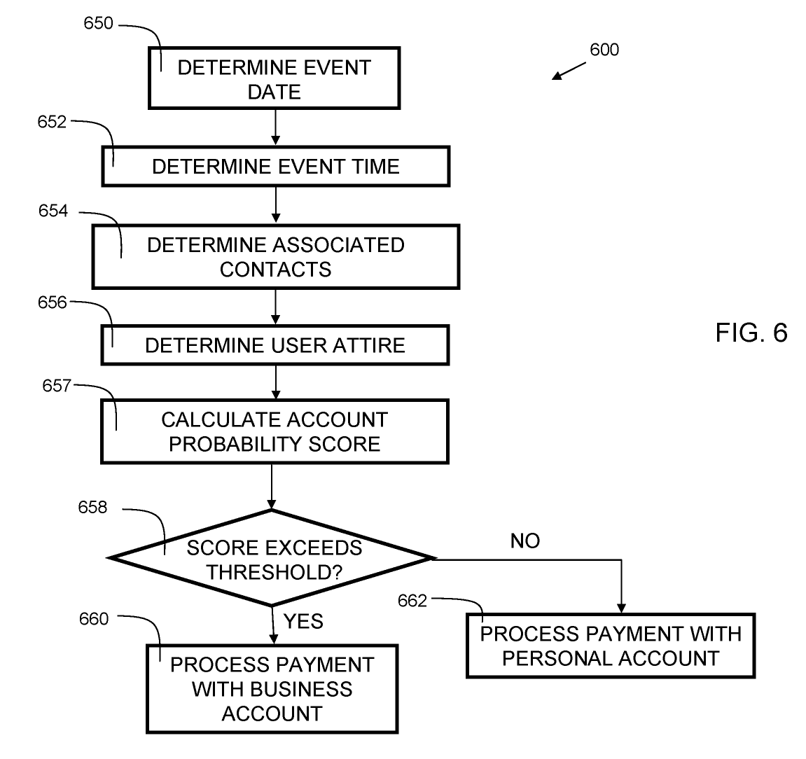

FIG. 6 is a flowchart 600 indicating process steps for account association in accordance with embodiments of the present invention. In some embodiments, purchase context is determined based on an event date and time, a user's associated contacts, and the user's attire. At 650, an event date is determined, and weight assigned. At 652, an event time is determined, and weight assigned. At 654, associated contacts are determined, and weights are assigned. At 656, user attire is determined, and weight assigned. At 657, an account probability score is calculated. At 658, it is determined whether the account probability score exceeds a predetermined threshold. If so, payment is associated with, and processed from, a business account, at 660. If not, payment is associated with, and processed from, a personal account, at 662.

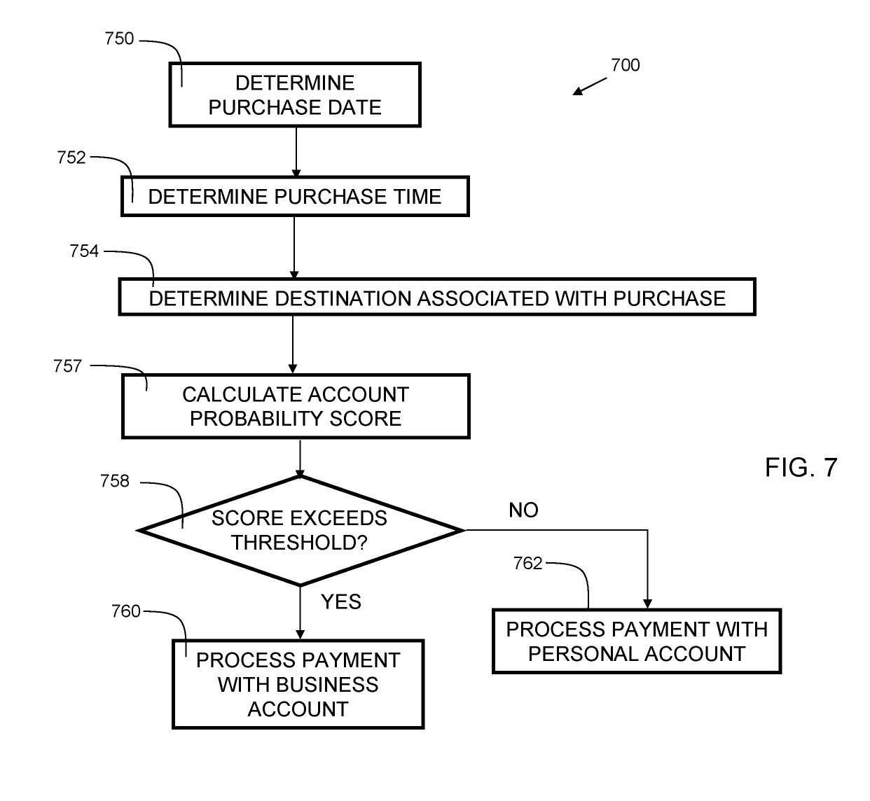

FIG. 7 is a flowchart 700 indicating process steps for account association in accordance with additional embodiments of the present invention. At 750, a purchase date is determined, and weight assigned. At 752, a purchase time is determined, and weight assigned. At 754, a destination associated with a purchase is determined, and weight assigned. At 757, an account probability score is calculated. At 758, it is determined whether the account probability score exceeds a predetermined threshold. If so, payment is associated with, and processed from, a business account, at 760. If not, payment is associated with, and processed from, a personal account, at 762.

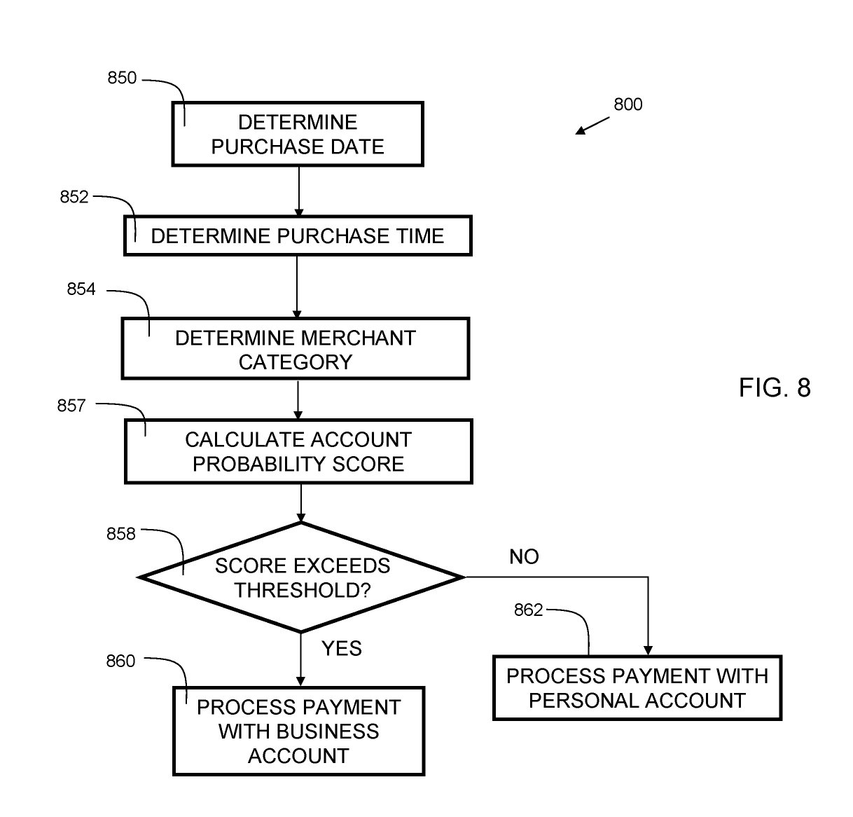

FIG. 8 is a flowchart 800 indicating process steps for account association in accordance with additional embodiments of the present invention. At 850, a purchase date is determined, and weight assigned. At 852, a purchase time is determined, and weight assigned. At 854, a merchant category is determined, and weight assigned. At 857, an account probability score is calculated. At 858, it is determined whether the account probability score exceeds a predetermined threshold. If so, payment is associated with, and processed from, a business account, at 860. If not, payment is processed from a personal account, at 862.

An example method of calculating the score includes the following. The example formula includes a scale of 100 points. A factor weight of 0 indicates a personal expense, a factor weight of 5 indicates a neutral weight, and a factor weight of 10 indicates a business expense. In some embodiments, the distance from the neutral weight can be interpreted as a confidence level. The farther the distance from neutral, the higher the confidence of a particular account association. Where exactly on the scale the weight is assigned is based on a confidence level of the weight. In embodiments, the closer to 0 or 10, the more confidence in the weight, whereas the closer to 5, the less confidence. In some embodiments, the range can be from 0 to 100, 0 to 1,000, or other suitable range. In the example, the account probability score is on a 100 scale. The threshold is 50. If the score is 50 or over, the purchase is determined to be a business expense. If the score is less than or equal to 50, it is determined to be a personal expense. In the example, there are 9 factors, and the associated assigned weights are assigned as follows:

Event date: 9
Event time: 8
One or more contacts associated with the event: 2
Check-in data: 5
Destination associated with a purchase: 8
Geographic location of the purchase: 7
Merchant identification: 3
User attire: 3
User contacts: 2

The weights are added up for a total of 47, multiplied by 100, and divided by 90 in order to fit it on a 100 scale. The resulting account probability score is 52.2. Accordingly, since the score is over the threshold of 50, it is determined that the expense is a business expense and associated with the user's business account. Note that the aforementioned calculations are merely exemplary, and other weighting factors and algorithms are possible. Accordingly, the purchase is charged to a business account of the user.

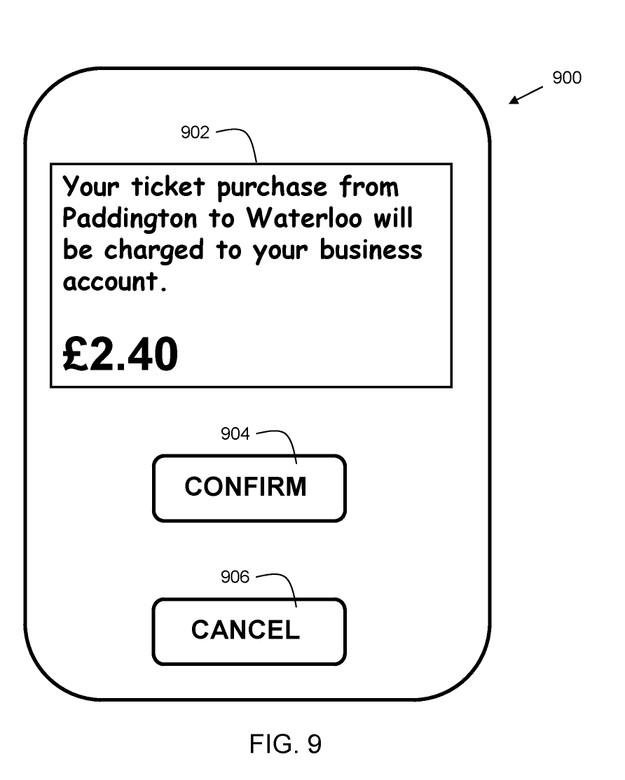

FIG. 9 is an exemplary user interface 900 for account confirmation in accordance with embodiments of the present invention. In some embodiments, a display is presented on a user interface of the user's mobile device in response to a determination of account. In the example, information relating to the purchase is shown at 902. It may include an identifier of the item purchased, data about the item, cost, determined account, and/or other suitable information. In the example, the item is a ticket. The presented data is that the ticket is from Paddington to Waterloo at a cost of £2.40. The determined account is the business account. An option 904 is presented for the user to confirm the purchase if it is correct. Option 906 is presented for the user to cancel the purchase if incorrect. In the example, the options are buttons, which can be selected by a user touching his or her finger, or a stylus, to a touch-sensitive screen. It should be recognized that buttons are an example modality, and in other embodiments, the options may be radio buttons, drop-down menus, voice commands, or other suitable mechanism. If the user selects to confirm the purchase, the purchase is executed from the stated account. If the user selects to cancel the purchase, the purchase is not executed.

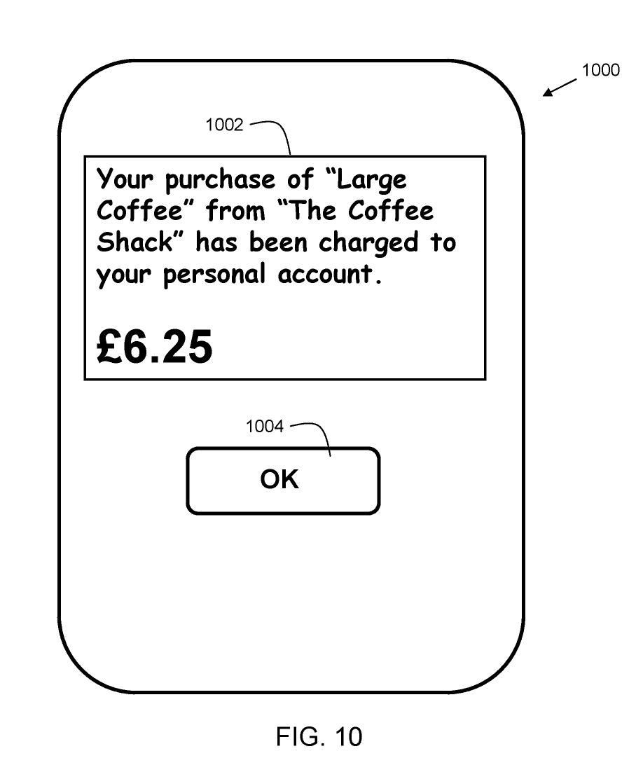

FIG. 10 is an exemplary user interface 1000 for automatic account selection in accordance with embodiments of the present invention. In some embodiments, a user interface 1000 is presented on a display of the user's mobile device in response to execution of a purchase from the determined account. In the example, information relating to the purchase is shown at 1002. It may include an identifier of the item purchased, data about the item, merchant where the item was purchased, cost, determined account, and/or other suitable information. In the example, the item is coffee. The presented data is that the coffee is from The Coffee Shack at a cost of £6.25. The determined account is the personal account. Therefore, the purchase is charged to the present account of the user. An option 1004 is presented for the user to acknowledge the information. In the example, the option is a button, which can be selected by a user touching his or her finger, or a stylus, to a touch-sensitive screen. It should be recognized that a button is an example modality, and in other embodiments, the option may be a radio button, drop-down menu, voice command, or other suitable mechanism.

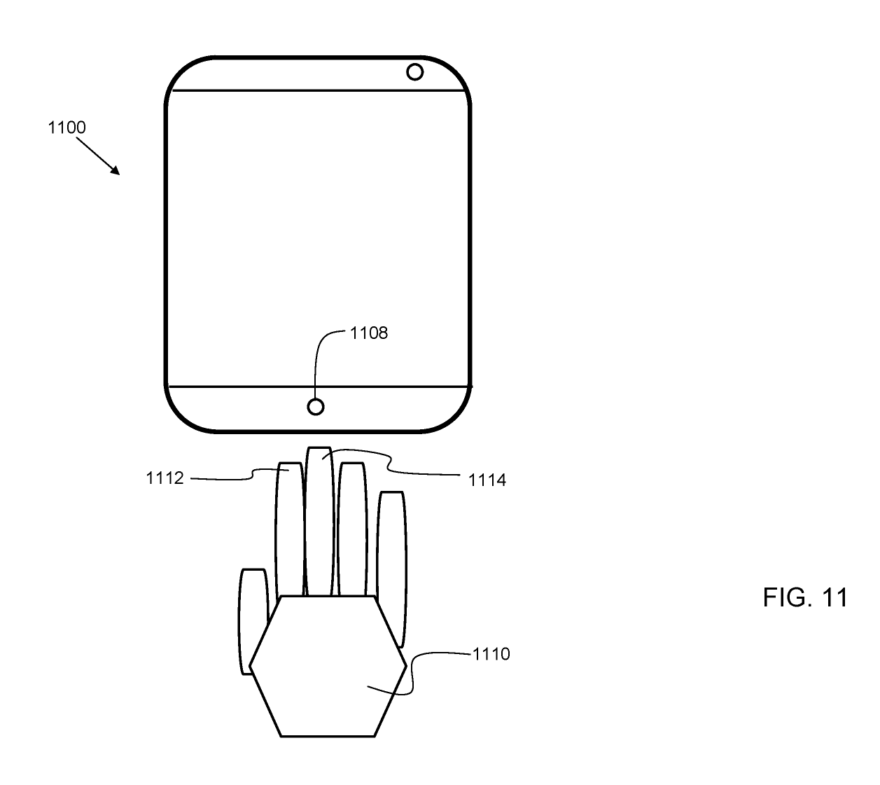

FIG. 11 illustrates associating the purchase with the account in response to detecting a fingerprint from a fingerprint sensor. A user may specify that a scan of a first particular finger of his/her hand 1110 specifies a first account, and a scan of a second particular finger specifies a different account. These settings may be set by the user through an application user interface, and transmitted to rules engine 222 (FIG. 2). A user may scan his/her index finger 1112 and middle finger 1114 on a fingerprint sensor 1108 on his/her phone 1100, and indicate the index finger 1112 specifies a personal account, and the middle finger 1114 specifies a business account. When the user then goes to make a purchase using his/her mobile electronic device (e.g. phone), and scans her index finger 1112 on the fingerprint sensor 1108 of his/her phone 1100, the rules indicate to assign the purchase a high likelihood of being a personal account. When instead, s/he scans her middle finger 1114, the rules may indicate to assign the purchase a high likelihood of being a business expense.

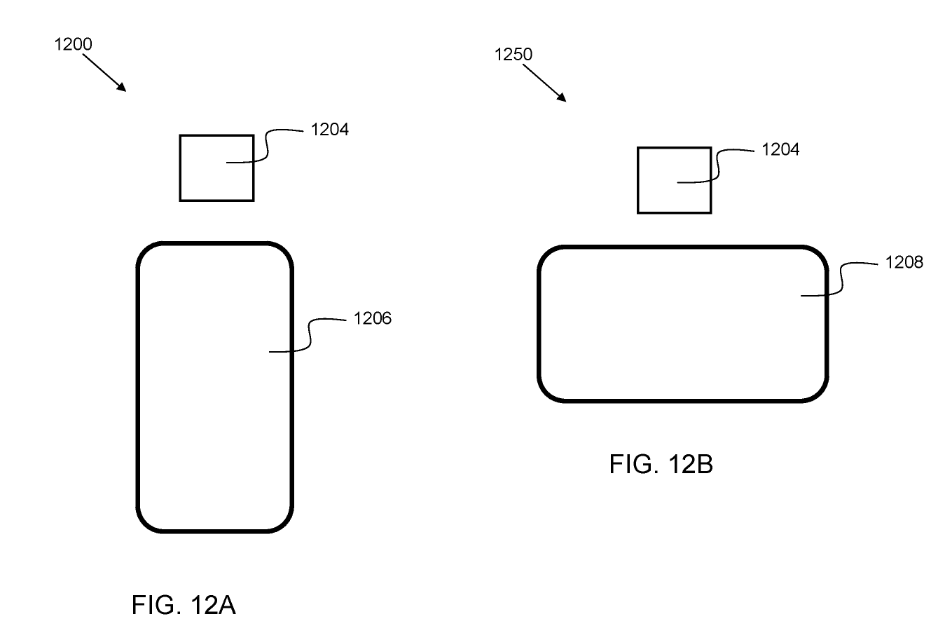

FIG. 12A and FIG. 12B illustrate account association based on device orientation. A user may specify that a first orientation of his/her phone specifies a first account, and a second orientation of the phone specifies a different account. These settings may be set by the user through an application user interface. A user may manually input these setting to his/her phone, and indicate that a horizontal (landscape) position specifies a personal account, and a vertical (portrait) position specifies a business account. When the user then goes to make a purchase using his/her electronic mobile device (e.g. phone), and intends it to be charged to a personal account, s/he holds the phone in a horizontal orientation towards a near field communication (NFC) enabled point-of-sale (PoS) scanner 1204. When instead, she intends the purchase to be charged to a business account, s/he holds the phone in a horizontal orientation. In FIG. 12A, diagram 1200 shows a user phone 1206 in a “portrait” orientation facing PoS scanner 1204. In FIG. 12B, diagram 1250 shows a user phone 1208 in a “landscape” orientation facing PoS scanner 1204. The rules engine may have rules indicating that a purchase executed in portrait orientation is to be assigned a weight indicating a high likelihood of being a business expense, while a purchase executed in landscape is to be assigned a weight indicating high likelihood of being a personal expense. Accordingly, the purchase in FIG. 12A is assigned a weight indicating a business expense, and the purchase in FIG. 12B is assigned a weight indicating a personal expense.

As can now be appreciated, disclosed embodiments enable a user to conveniently and easily associate purchases with the appropriate account when making purchases on a mobile device. In this way, the management of multiple accounts, such as personal and business accounts becomes greatly simplified.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

What is claimed is:

1. A computer-implemented method for determining a correct account for a purchase, comprising:
obtaining context information from one or more electronic information systems;
determining a probability score of the purchase corresponding to an account, based on the obtained context information from the one or more electronic information systems; and
associating the purchase with the account in response to the probability score exceeding a predetermined threshold.

2. The method of claim 1, wherein the context information includes an event classification for an event.

3. The method of claim 2, wherein the context information includes one or more contacts associated with the event.

4. The method of claim 3, wherein the one or more contacts are identified by a computer-implemented facial recognition process performed on an image acquired by a user device.

5. The method of claim 2, wherein the context information includes an event time for the event.

6. The method of claim 1, further comprising:
obtaining a merchant identification for the purchase; and
wherein determining a probability score of the purchase corresponding to an account is further based on the merchant identification.

7. The method of claim 1, further comprising:
obtaining a geographic location for the purchase; and
wherein determining a probability score of the purchase corresponding to an account is further based on the geographic location.

8. An electronic device comprising:
a processor;
a memory coupled to the processor, the memory containing instructions, that when executed by the processor, perform the steps of:
obtaining context information from one or more electronic information systems;
determining a probability score of a purchase corresponding to an account, based on the obtained context information from the one or more electronic information systems; and
associating the purchase with the account in response to the probability score exceeding a predetermined threshold.

9. The electronic device of claim 8, wherein the memory further contains instructions, that when executed by the processor, perform the step of obtaining context information that includes an event classification for an event.

10. The electronic device of claim 9, wherein the memory further contains instructions, that when executed by the processor, perform the step of obtaining context information that includes one or more contacts associated with the event.

11. The electronic device of claim 10, further comprising a digital camera, and wherein the memory further contains instructions, that when executed by the processor, perform the step of identifying the one or more contacts by a computer-implemented facial recognition process performed on an image acquired by the digital camera of the electronic device.

12. The electronic device of claim 10, further comprising an orientation sensor, and wherein the memory further contains instructions, that when executed by the processor, perform the step of associating the purchase with the account in response to an orientation of the electronic device obtained from the orientation sensor.

13. The electronic device of claim 10, further comprising a fingerprint sensor, and wherein the memory further contains instructions, that when executed by the processor, perform the step of associating the purchase with the account in response to detecting a fingerprint from the fingerprint sensor, wherein the associated account is a business account when a fingerprint of a first finger is detected, and wherein the associated account is a personal account when a fingerprint of a second finger is detected.

14. The electronic device of claim 9, wherein the memory further contains instructions, that when executed by the processor, perform the step of obtaining context information that includes an event time for the event.

15. The electronic device of claim 8, wherein the memory further contains instructions, that when executed by the processor, perform the steps of:
determining a probability score of the purchase corresponding to an account, based on the obtained context information from the one or more electronic information systems; and
associating the purchase with the account in response to the probability score exceeding a predetermined threshold.

16. The electronic device of claim 8, wherein the memory further contains instructions, that when executed by the processor, perform the steps of:
obtaining a geographic location for the purchase; and
wherein determining a probability score of the purchase corresponding to an account is further based on the geographic location.

17. A computer program product for determining a correct account for a purchase on an electronic computing device, the electronic computing device comprising a computer readable storage medium having program instructions embodied therewith, the program instructions executable by a processor to cause the electronic computing device to:
obtain context information from one or more electronic information systems;
determine a probability score of the purchase corresponding to an account, based on the obtained context information from the one or more electronic information systems; and
associate the purchase with the account in response to the probability score exceeding a predetermined threshold.

18. The computer program product of claim 17, further comprising program instructions executable by the processor to cause the electronic computing device to:
obtain a merchant identification for the purchase; and
determine a probability score of the purchase corresponding to an account based on the merchant identification.

19. The computer program product of claim 17, further comprising program instructions executable by the processor to cause the electronic computing device to:
obtain an image of a user performing the purchase; and
determine a probability score of the purchase corresponding to an account based on a computerized attire analysis of the user.

20. The computer program product of claim 17, further comprising program instructions executable by the processor to cause the electronic computing device to:
obtain a destination associated with the purchase; and
determine a probability score of the purchase corresponding to an account based on the destination.
